(19) United States
(12) Patent Application Publication
(10) Pub. No.: US 2008/0278317 A1
(43) Pub. Date: Nov. 13, 2008

(54) REAL-TIME MONITOR SYSTEM

(75) Inventors: Chiu-Yuan Lin, Taipei City (TW); Yang-Han Lee, Taipei City (TW); Han-Kuo Yeh, Taipei City (TW); Yiu-Sung Pao, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: BEYOND INNOVATION TECHNOLOGY CO., LTD., Taipei City (TW)

(21) Appl. No.: 12/046,437

(22) Filed: Mar. 11, 2008

(30) Foreign Application Priority Data
May 8, 2007 (TW) 96116273

(51) Int. Cl. G05B 11/12; H04Q 7/20

(52) U.S. Cl. 340/539.24; 340/310.16

(57) ABSTRACT

A real-time monitor system including at least one public facility, a second wireless transceiver, and a control center is provided. The public facility includes a power generator, a load, a signal generator, and a first wireless transceiver. An initial power provided by the power generator drives the load. The signal generator determines whether or not to output a condition signal and a positioning signal according to whether the load is driven. Then, the condition signal and the positioning signal are emitted to the second wireless transceiver by the first wireless transceiver. Therefore, the control center determines the service condition of the public facility according to the information of the condition signal or whether the condition signal is received, and determines the position of the public facility according to the positioning signal.

### CROSS-REFERENCE TO RELATED APPLICATION

This application claims the priority benefit of Taiwan application serial no. 96116273, filed on May 8, 2007. The entirety the above-mentioned patent application is hereby incorporated by reference herein and made a part of specification.

### BACKGROUND OF THE INVENTION

1. Field of the Invention

The present invention relates to a real-time monitor system. More particularly, the present invention relates to a real-time monitor system controlling public facilities.

2. Description of Related Art

In order to improve urban life and working environment, the government arranges various public facilities concerning public benefits, for example traffic signs, street lamps, telecom boxes, fire hydrants, etc. Herein, the public facility is mainly used to enhance the convenience of the public activities, and to assure superior life quality, so as to achieve substantiality that can be directly, quickly, and easily perceived by the mass.

With the development of urbanization, the public facilities in the city become complex increasingly, and the living environment is full of various public facilities. Therefore, it becomes an inevitable topic in urban development how to manage and maintain the existing public facilities. As far as the current management of the public facilities is concerned, besides a few of public affairs units are energetic to establish information management system, for example, Chunghwa Telecom, Private Fixed-Network, and Taiwan Power Company, etc, most of the public affairs units still use the conventional working method to handle the business.

According to the conventional working method, the public facilities usually use the on-spot examination of the public facilities made by the maintainers or the complaints of the mass to judge whether the public facilities are damaged or not, which incurs greater human resource expenses, and it is impossible to repair the existing public facilities on time. Relatively, the service quality of the public affairs units cannot be improved, and the business burden becomes heavy. Therefore, for the above chock points, the public affairs units are in urgent need of a scientific monitor system to assist the promotion of the business.

### SUMMARY OF THE INVENTION

Accordingly, the present invention is directed to providing a real-time monitor system, for acquiring the use condition of the public facility in real time, so as to reduce the human resource consumption and to achieve in-time maintenance.

A real-time monitor system including at least one public facility, a second wireless transceiver, and a control center is provided. The public facility includes a power generator, a load, a signal generator, and a first wireless transceiver. An initial power provided by the power generator drives the load. When the load is driven, the signal generator outputs a condition signal and a positioning signal accordingly. Otherwise, the signal generator cannot output the condition signal and the positioning signal normally. The first wireless transceiver emits the condition signal and the positioning signal by means of an electromagnetic wave in space. On the other hand, the control center receives the condition signal and the positioning signal through the second wireless transceiver. Accordingly, the control center determines the use condition of the public facility according to whether the information of the condition signal or the condition signal is received, and determines the position of the public facility according to the positioning signal.

In an embodiment of the present invention, the public facility further includes a power management apparatus and a condition detector. The power management apparatus is used to convert the initial power provided by the power generator to a display voltage, and the display voltage is used to drive the load. The condition detector is used to detect the characteristic parameter of the load, the power generator, and the power management apparatus, and generates a load using information, a power generating information, and a power management information to the signal generator according to the detected characteristic parameter.

Next, the signal generator compares the load using information, the power using information, and the power management information respectively with a normal value, and when one of the load using information, the power generating information, and the power management information is smaller than the corresponding normal value, the signal generator generates the warning information, otherwise, the signal generator generates the loss information. In addition, the warning information or the loss information is contained in the condition signal, such that the control center determines the use condition of the public facility according to the information of the condition signal.

In an embodiment of the present invention, the power generator includes a multi-layer substrate, a solar panel, an auxiliary positioning system receiver, and an antenna. The multi-layer substrate has a first layer and a second layer, the solar panel and the antenna are disposed on the first layer, and the auxiliary positioning system receiver is disposed on the second layer. In space, the solar panel and the antenna are stacked on each other and disposed at the same level, so it contributes to reduce the hardware space of the power generator, and when the power generator fails to make all the systems not act, the solar panel can charge by itself to provide power to the signal generator to generate the warning information to the control center.

In addition, the auxiliary positioning system receiver is driven according to the power provided by the solar panel, and is used to acquire longitude and latitude coordinates of the public facility to generate the auxiliary positioning signal accordingly. The antenna is used to emit the auxiliary positioning signal to the second wireless transceiver, such that the control center determines the position of the public facility according to the auxiliary positioning signal received by the second wireless transceiver.

It should be noted that the signal generator includes a global positioning system receiver. The global positioning system receiver acquires the longitude and latitude coordinates of the public facility through a satellite signal of the global positioning system, so as to generate the positioning signal accordingly. In addition, in an embodiment of the present invention, the public facility includes a traffic light or a street lamp, and the load is a light emitting diode (LED).

The present invention uses the combination of the signal generator and the public facility to acquire the use condition of the public facility in real time. The first wireless transceiver and the second wireless transceiver mutually transmit the signal, the control center can determine the use condition of the public facility in real time, and to send workers to repair the public facility in time, so as to achieve the function of reducing the human resource consumption and in-time maintenance.

In order to make the aforementioned and other objects, features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 shows a real-time monitor system according to an embodiment of the present invention.

FIG. 2 shows a real-time monitor system according to another embodiment of the present invention.

FIG. 3 shows a real-time monitor system according to still another embodiment of the present invention.

FIG. 4 is a schematic structural view of a multi-layer substrate.

### DESCRIPTION OF EMBODIMENTS

The technical feature of the present invention mainly includes utilizing the combination of the signal generator and the public facility for the control center monitoring the public facility to acquire the use condition of the public facility in real time, so as to reduce the human resource consumption and to achieve the function of in-time maintenance. Hereinafter, embodiments are listed to illustrate the real-time monitor system of the present invention, but are not intended to limit the present invention. Those skilled in the art can modify the embodiments according to the spirit of the present invention, without departing from the scope of the present invention.

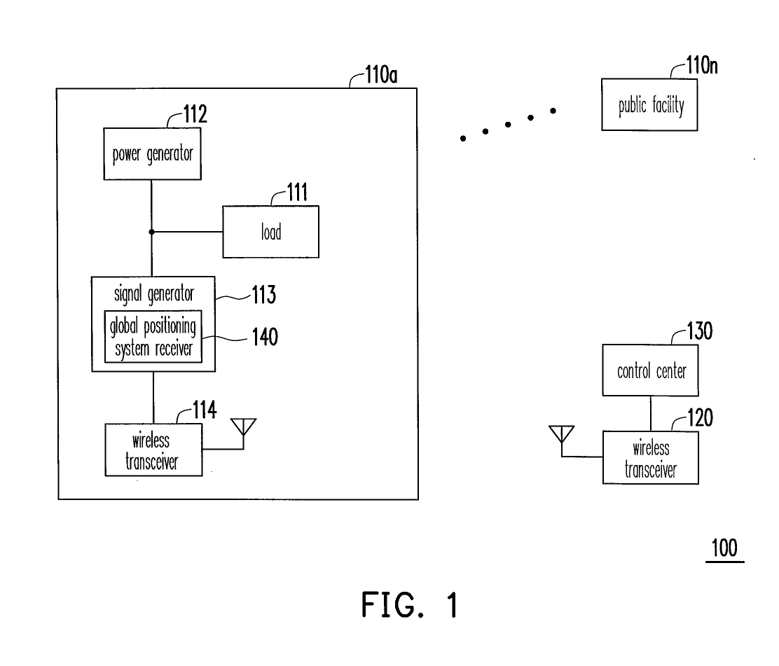

Referring to FIG. 1, a real-time monitor system according to an embodiment of the present invention is shown. The real-time monitor system 100 of this embodiment includes a plurality of public facilities 110a-110n, a wireless transceiver 120, and a control center 130. The internal components of the public facilities 110a-110n are the same, so in the following description, the operation mechanism of the public facility 110a, the wireless transceiver 120, and the control center 130 is described to illustrate this embodiment.

Referring to FIG. 1, the public facility 110a includes a load 111, a power generator 112, a signal generator 113, and a wireless transceiver 114. The wireless transceiver 120 is coupled to the control center 130. The load 111 and the signal generator 113 are coupled to the power generator 112. The wireless transceiver 114 is coupled to the signal generator 113.

The power generator 112 is used to provide an initial power, such that the load 111 is driven by the initial power. When the load 111 is driven, the signal generator 113 outputs a condition signal and a positioning signal accordingly, and the signal generator 113 generates the positioning signal according to the longitude and latitude coordinates of the public facility 110a. Here, the public facility 110a emits the condition signal and the positioning signal by means of an electromagnetic wave in space through the wireless transceiver 114. On the other hand, the wireless transceiver 120 receives the condition signal and the positioning signal by means of the electromagnetic wave in space, such that the control center 130 determines the use condition and the position of the public facility 110a according to the condition signal and the positioning signal.

On the other hand, when the power generator 112 is abnormal or damaged, that is, when it is impossible for the load 111 to be driven through the initial power provided by the power generator 112, the signal generator 113 cannot output the condition signal and the positioning signal to the wireless transceiver 114 normally. When the control center 130 cannot use the wireless transceiver 120 to receive the condition signal and the positioning signal transmitted from the wireless transceiver 114, so as to determine that the public facility 110a is abnormal at the time. In this manner, the control center 130 sends workers to repair the public facility 110a in time according to the positioning signal transmitted by the public facility 110a in normal condition.

Further, the signal generator 113 includes a global positioning system receiver 140. Here, the global positioning system receiver 140 acquires the longitude and latitude coordinates of the public facility 110a through the satellite signal of the global positioning system, so as to generate the positioning signal to the wireless transceiver 114 accordingly. Here, the global positioning system includes Euro Galilieo system or Russia global orbiting navigation satellite system (GLONSS).

It should be noted that the public facilities 110a-110n are common utilities concerning public benefits, for example the public facilities 110a-110n are a traffic light or a street lamp respectively. When the public facilities 110a-110n are a traffic light or a street lamp respectively, the load 111 is a display element, such that the public facilities 110a-110n provide the signs or the illumination required by the mass.

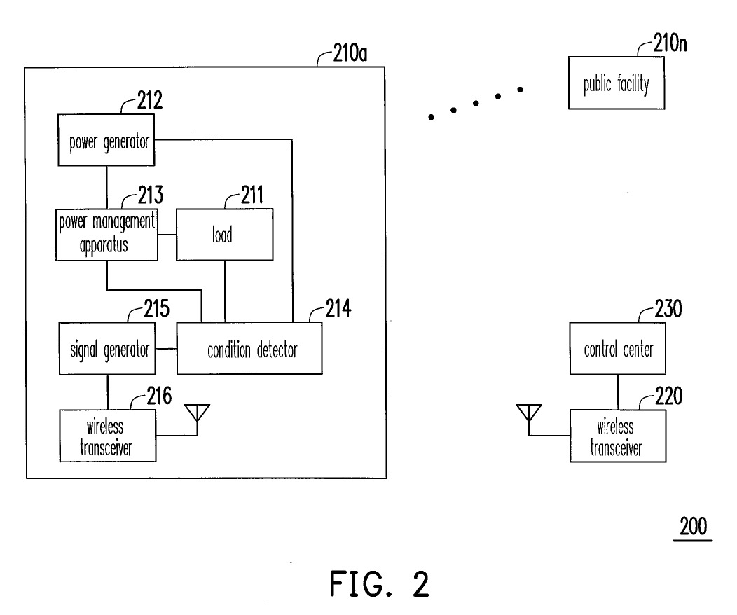

Referring to FIG. 2, a real-time monitor system according to another embodiment of the present invention is shown. The real-time monitor system 200 of this embodiment includes a plurality of public facilities 210a-210n, a wireless transceiver 220, and a control center 230. The internal components of the public facilities 210a-210n are the same, so in the following description, the operation mechanism of the public facility 210a, the wireless transceiver 220, and the control center 230 is described to illustrate this embodiment.

The public facility 210a includes a load 211, a power generator 212, a power management apparatus 213, a condition detector 214, a signal generator 215, and a wireless transceiver 216. The wireless transceiver 220 is coupled to the control center 230. The power management apparatus 213 is coupled to the load 211 and the power generator 212. The condition detector 214 is coupled to the load 211, the power generator 212, and the power management apparatus 213. The signal generator 215 is coupled to the condition detector 214. The wireless transceiver 216 is coupled to the signal generator 215.

The power generator 212 is used to provide an initial power, such that the load 211 is driven through the initial power. In this embodiment, when the initial power provided by the power generator 212 cannot directly drive the load 211, the initial power is converted to a display voltage through the power management apparatus 213, so as to drive the load 211. Definitely, those skilled in the art should know that when the load 211 is directly driven by the initial power, it is not necessary for the public facility 210a to have the power management apparatus 213. In other words, those skilled in the art can replace the power management apparatus 213 according to the requirement of the design.

When the load 211 is driven, the condition detector 214 can acquire the conversion efficiency of the load 211 by detecting the characteristic parameters (for example voltage, current, and temperature) of the load 211, and can generate a load using information according to the detected characteristic parameters. Similarly, the condition detector 214 acquires the conversion efficiency of the power generator 212 through the characteristic parameters (for example voltage, current, and temperature) of the power generator 212, and generates a power generating information according to the detected characteristic parameters. In addition, the condition detector 214 also acquires the conversion efficiency of the power management apparatus 213 by detecting the characteristic parameters (for example voltage, current, and temperature) of the power management apparatus 213, and generates a power management information according to the detected characteristic parameters.

The use conditions of the load 211, the power generator 212, and the power management apparatus 213 (for example, normal or abnormal, and the service life) can be evaluated through the conversion efficiency. Therefore, the signal generator 215 compares the load using information, the power generating information, and the power management information respectively with a normal value, and when one of the load using information, the power generating information, and the power management information is smaller than the corresponding normal value, the signal generator 215 generates the warning information to indicate that the internal components of the public facility 210a (for example the load 211 and the power management apparatus 213) may be abnormal. Otherwise, the signal generator 215 generates a loss information to indicate the conversion efficiency of the internal components of the public facility 210a.

Then, the signal generator 215 outputs the condition signal according to the comparison result, and outputs the positioning signal according to the longitude and latitude coordinates of the public facility 210a, in which the condition signal includes the warning information or the loss information. The wireless transceiver 216 is used to receive the condition signal and the positioning signal output by the signal generator 215, and emits the condition signal and the positioning signal by means of the electromagnetic wave in space. Otherwise, the control center 130 receives the condition signal and the positioning signal through the wireless transceiver 220, thereby determining the use condition and the position of the public facility 110a.

It is known from the above that when the load 211 is driven, the control center 130 acquires whether the internal components of the public facility 210a are normal and the service life, and so on through the condition signal received by the wireless transceiver 220. Therefore, the control center 130 performs suitable treatment on the public facility 110a, even determines the problem causing the abnormality of the public facility 110s, thereby reducing the time required in maintenance.

In addition, when the power generator 212 is abnormal or damaged, the power management apparatus 213 cannot provide the display voltage normally, such that the load 211 cannot act normally. At this time, the condition detector 214 cannot detect the characteristic parameters of the load 211, the power generator 212, and the power management apparatus 213, such that the signal generator 215 cannot output the condition signal and the positioning signal normally to the wireless transceiver 216.

At this time, the control center 230 cannot receive the condition signal and the positioning signal through the wireless transceiver 220, so it is determined that the public facility 210 is abnormal. In this manner, the control center 230 can send workers to repair the public facility 210a in time according to the positioning signal transmitted by the public facility 210a in normal condition. Other detailed description of this embodiment are included in the embodiment of FIG. 1, and will not be descried herein again.

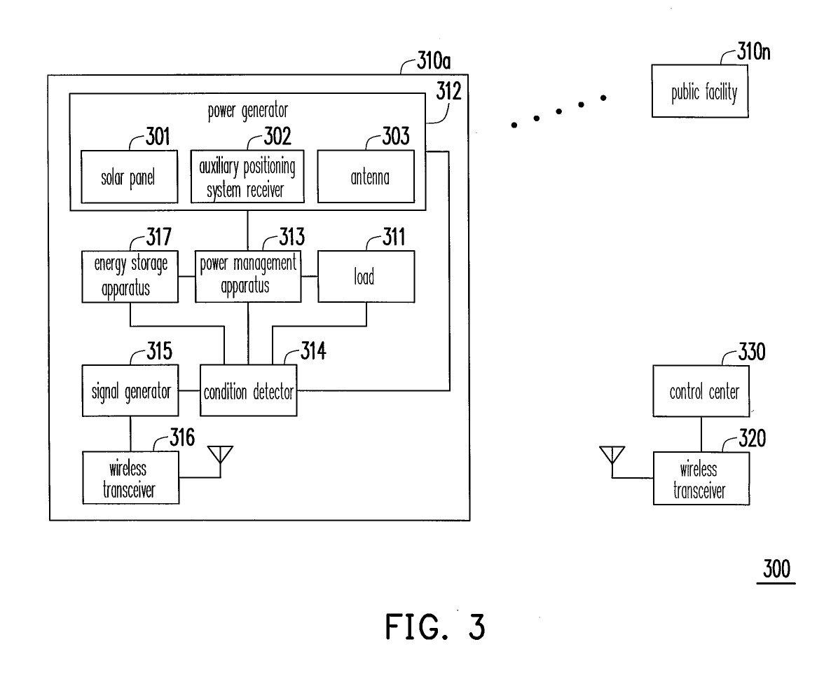

Referring to FIG. 3, a real-time monitor system according to still another embodiment of the present invention is shown. The real-time monitor system 300 of this embodiment includes a plurality of public facilities 310a-310n, a wireless transceiver 320, and a control center 330. The internal components of the public facilities 310a-310n are the same, so in the following description, the operation mechanism of the public facility 310a, the wireless transceiver 320, and the control center 330 is described to illustrate this embodiment.

Referring to FIG. 3, the public facility 310a includes a load 311, a power generator 312, a power management apparatus 313, a condition detector 314, a signal generator 315, a wireless transceiver 316, and an energy storage apparatus 317. The wireless transceiver 320 is coupled to the control center 330. The power management apparatus 313 is coupled to the load 311, the power generator 312, and the energy storage apparatus 317. The condition detector 314 is coupled to the load 311, the power generator 312, the power management apparatus 313, and the energy storage apparatus 317. The signal generator 315 is coupled to the condition detector 314. The wireless transceiver 316 is coupled to the signal generator 315.

The operation mechanism of the real-time monitor system 300 of this embodiment is similar to the above embodiments, the condition detector 314 is used to detect the internal components (for example load 311, and power management apparatus 313) of the public facility 310a, so as to make the signal generator 315 output the condition signal and the positioning signal. Then, the public facility 310a and the control center 330 acquire communication with each other through the wireless transceivers 316 and 320. The control center 330 determines the use condition and the position of the public facility 310a according to the condition signal and the positioning signal.

However, the main difference is that the public facility 310a of this embodiment includes the energy storage apparatus 317. Therefore, the power management apparatus 313 convert the initial power generated by the power generator 312 to a display voltage and an energy storage voltage. The display voltage is used to drive the load 311, and the energy storage apparatus 317 stores the power provided by the power generator 312 according to the energy storage voltage. Therefore, when the power generator 312 cannot provide enough power to the public facility 310a, the public facility 310a can maintain the original function through the power stored by the energy storage apparatus 317.

In addition, the condition signal output by the signal generator 315 also include the warning information or the loss information. Here, the energy storage apparatus 317 is also one of the internal components of the public facility 310a, so the condition detector 314 here can generate the load using information, the power generating information, and the power management information by detecting the load 311, the power generator 312, and a power management apparatus 313. In addition, the condition detector 314 can also detect the characteristic parameters (for example voltage, current, and temperature) of the energy storage apparatus 317, so as to acquire the storage efficiency of the energy storage apparatus 317, and to generate an energy storage information according to the characteristic parameters.

The use conditions (for example, normal or abnormal, and the service life) of the energy storage apparatus 317 can be evaluated through the storing efficiency. Therefore, the signal generator 215 compares the load using information, the power generating information, the power management information, and the energy storage information respectively with a normal value. When one of the load using information, the power generating information, the power management information, and the energy storage information is smaller than the corresponding normal value, the signal generator 215 generates the warning information. Otherwise, the signal generator 215 generates the loss information.

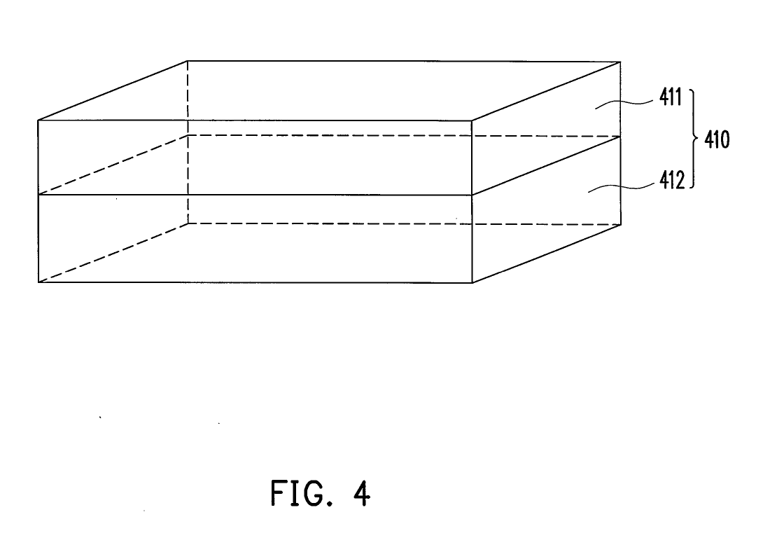

Further, the power generator 312 of this embodiment includes a multi-layer substrate 410 (not shown), a solar panel 310, an auxiliary positioning system receiver 302, and an antenna 303. In the schematic structural view of the multi-layer substrate as shown in FIG. 4, the multi-layer substrate 410 has a first layer 411 and a second layer 412, the solar panel 301 and the antenna 303 are simultaneously disposed on the first layer 411, and the auxiliary positioning system receiver 302 is disposed on the second layer 412.

In this embodiment, the solar panel 301 and the antenna 303 are stacked on each other in space (the antenna is disposed under the solar panel), and disposed at the same level, thereby effectively reducing the hardware space of the power generator 312. In addition, those skilled in the art should know that the layer on which the solar panel 301, the auxiliary positioning system receiver 302, and the antenna 303 are disposed can be randomly altered according to the requirements of the design, so is not limited to the above disposition.

Referring to FIG. 3, the solar panel 301 is used to absorb the solar energy, and is used to convert the received solar energy to the electric energy. When the internal components (for example, the load 311 and the power management apparatus 313) of the public facility 210a fails or is damaged, the auxiliary positioning system receiver 302 in the power generator 312 can be driven according to the power provided by the solar panel 301. Here, the auxiliary positioning system receiver 302 acquires the longitude and latitude coordinates of the public facility through the satellite signal of the global positioning system, and generates an auxiliary positioning signal accordingly. Next, the antenna 303 emits the auxiliary positioning signal to the wireless transceiver 320, such that the control center 330 determines the position of the public facility 310a according to the auxiliary positioning signal.

In other words, when the load 311 cannot act normally, the control center 330 can acquire the longitude and latitude coordinates of the public facility 310a according to the positioning signal or the auxiliary positioning signal transmitted by the public facility 310a in normal condition, so as to send workers to repair the public facility 210a in time. Other details of this embodiment are included in the above embodiments, and will not be descried herein.

To sum up, in the present invention, the condition detector is used to acquire the use condition of the internal component of the public facility, such that the signal generator can output the condition signal and the positioning signal according to the information generated by the condition detector. Therefore, the control center acquires the condition signal and the positioning signal through the wireless transceiver, and determines the use condition and the position of the public facility accordingly. In this manner, the control center acquires the use condition of the public facility in real time, thereby reducing the human resource consumption and achieving the function of in-time maintenance.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A real-time monitor system, comprising:
at least one public facility, comprising:
a power generator, for providing an initial power;
a load, driven by the initial power;
a signal generator, determining whether or not to output a condition signal and a positioning signal according to whether the load is driven; and
a first wireless transceiver, for emitting the condition signal and the positioning signal;
a second wireless transceiver, for receiving the condition signal and the positioning signal; and
a control center, coupled to the second wireless transceiver, determining a use condition of the public facility according to the condition signal or the positioning signal, and determining the position of the public facility according to the positioning signal.

2. The real-time monitor system as claimed in claim 1, wherein the condition signal comprises a warning information or a loss information, and the public facility further comprises:
a condition detector, for detecting a characteristic parameter of the load and the power generator, and generating a load using information and a power generating information according to the characteristic parameter,
wherein the signal generator compares the load using information and the power using information respectively with a normal value, and generates the warning information or the loss information according to the comparison result.

3. The real-time monitor system as claimed in claim 2, wherein when the load using information or the power generating information is smaller than the corresponding normal value, the signal generator generates the warning information, otherwise, the signal generator generates the loss information.

4. The real-time monitor system as claimed in claim 2, wherein the characteristic parameter comprises current, voltage, and temperature.

5. The real-time monitor system as claimed in claim 1, wherein the public facility further comprises:
a power management apparatus, for converting the initial power into a display voltage, wherein the display voltage is used to drive the load.

6. The real-time monitor system as claimed in claim 5, wherein the condition signal comprises a warning information or a loss information, and the public facility further comprises:
a condition detector, for detecting a characteristic parameter of the load, the power generator, and the power management apparatus, and generating a load using information, a power generating information, and a power management information according to the characteristic parameter,
wherein the signal generator compares the load using information, the power using information, and the power management information respectively with a normal value, and generates the warning information or the loss information according to the comparison result.

7. The real-time monitor system as claimed in claim 6, wherein when one of the load using information, the power generating information, and the power management information is smaller than the corresponding normal value, the signal generator generates the warning information, otherwise, the signal generator generates the loss information.

8. The real-time monitor system as claimed in claim 6, wherein the characteristic parameter comprises current, voltage, and temperature.

9. The real-time monitor system as claimed in claim 1, wherein the public facility further comprises:
a power management apparatus, for converting the initial power into a display voltage and an energy storage voltage, wherein the load is driven according to the display voltage; and
an energy storage apparatus, for storing the power provided by the power generator according to the energy storage voltage.

10. The real-time monitor system as claimed in claim 9, wherein the condition signal comprises a warning information or a loss information, and the public facility further comprises:
a condition detector, for detecting a characteristic parameter of the load, the power generator, the power management apparatus, and the energy storage apparatus, and generating a load using information, a power generating information, a power management information, and an energy storage information according to the characteristic parameter,
wherein the signal generator compares the load using information, the power using information, the power management information, and the energy storage information respectively with a normal value, and generates the warning information or the loss information according to the comparison result.

11. The real-time monitor system as claimed in claim 9, wherein when one of the load using information, the power generating information, the power management information, and the energy storage information is smaller than the corresponding normal value, the signal generator generates the warning information, otherwise, the signal generator generates the loss information.

12. The real-time monitor system as claimed in claim 9, wherein the characteristic parameter comprises current, voltage, and temperature.

13. The real-time monitor system as claimed in claim 1, wherein the signal generator comprises:
a global positioning system receiver, acquiring longitude and latitude coordinates of the public facility through a satellite signal of the global positioning system, so as to generate the positioning signal accordingly.

14. The real-time monitor system as claimed in claim 13, wherein the global positioning system comprises a Euro Galileo system or a Russia global orbiting navigation satellite system (GLONSS).

15. The real-time monitor system as claimed in claim 1, the power generator comprises:
a multi-layer substrate, having a first layer and a second layer;
a solar panel, disposed on the first layer;
an auxiliary positioning system receiver, disposed on the second layer and driven by the power provided by the solar panel, and used to acquire the longitude and latitude coordinates of the public facility to generate an auxiliary positioning signal accordingly; and
an antenna, disposed on the first layer, for emitting the auxiliary positioning signal to the second wireless transceiver,
wherein the control center determines the position of the public facility according to the auxiliary positioning signal received by the second wireless transceiver.

16. The real-time monitor system as claimed in claim 1, wherein the public facility comprises a traffic light or a street lamp.

17. The real-time monitor system as claimed in claim 1, wherein the load is a light emitting diode.
